(19) United States
(12) Patent Application Publication
(10) Pub. No.: US 2014/0085870 A1
(43) Pub. Date: Mar. 27, 2014

(54) RECHARGEABLE SOLAR CHIP BATTERY SYSTEM

(71) Applicant: Mary Yacoub Abas, Beverly Hills, CA (US)

(72) Inventor: Mary Yacoub Abas, Beverly Hills, CA (US)

(73) Assignee: Mary Yacoub Abas

(21) Appl. No.: 14/054,437

(22) Filed: Oct. 15, 2013

(51) Int. Cl. F21L 4/08; H02J 7/35; H02J 7/02; F21V 33/00

(52) U.S. Cl. CPC F21L 4/08; F21V 33/0008; H02J 7/35; H02J 7/025
USPC 362/103; 362/183; 320/101

(57) ABSTRACT

A solar chip battery system including an interchangeable solar chip, a latch, and a battery unit suitable for use with an illumination means. The solar chip can be detached from the battery unit using the latch. The battery unit comprises at least one battery and a power switch. The battery unit is connected to an illumination means. The solar chip converts light energy into electric energy to recharge the battery unit, which stores the energy and provides power to the illumination means. The solar chip battery system can also provide power to an illumination means for use in portable applications, and can be recharged when not in use.

### FIELD OF THE INVENTION

The present invention relates to solar powered battery systems, particularly a portable, wearable and rechargeable solar chip battery system for use with an illumination means.

### BACKGROUND OF THE INVENTION

Many applications call for use of a portable, self-rechargeable battery suitable for powering an illumination means. Most outdoor activities that can be performed outside during hours of limited sunlight can benefit from the use of a means for illumination. Even activities done during daylight can benefit from the extra visibility given by extra light, such as, for example, daylight running lights on automobiles. The source of light can not only provide a means that can aid visibility, but in many instances an illumination means can also aid in keeping a user safe. In addition, it would not be possible to undertake some activities without some source of light. For example, directing traffic or riding a bicycle at night would be too dangerous without some illumination means. Also, some items would enjoy an aesthetic benefit from an illumination means, e.g. a hat or belt.

Presently, in many of these previously mentioned applications battery-operated light sources are employed. Batteries, however, tend to lose power quickly and need to be replaced often, or need to be recharged for long periods of time which make them ineffective or costly to operate. Some applications employ reflectors to reflect available sources of light, but these do not perform well when there is very limited light available. Some applications use solar power, but the existing options are limited in power output, battery, or design of the solar cell.

Many of these devices are also limited to one single application. Battery operated devices, such as, for example, flashlights are not suitable for use on a safety vest. Similarly, reflectors cannot produce their own light as a flashlight does and require external illumination sources. Also, many solar devices are fixedly coupled to a single application, such as a solar panel mounted to a lawn light.

Therefore there is need for a portable, wearable and rechargeable solar chip battery system for use with an illumination means.

### SUMMARY OF THE INVENTION

The present invention addresses the needs lacking in the present art by providing a portable, wearable and rechargeable solar chip battery system for use with an illumination means.

In the present invention, a solar chip is coupled to a rechargeable battery to provide a source of power to an illumination means. The solar chip provides a means to convert light energy to electrical energy. The battery can then store that energy and transfer it to power an illumination means when desired. The battery is rechargeable so it can repeatedly store and transfer the energy converted by the solar chip to the illumination means, and recharge once the energy has been consumed or the illumination means is turned off. In a preferred version of the invention, the solar chip a monocrystalline silicon chip capable of generating 0.18 W of power, with dimensions of 50 mm of length, by 30 mm of width, and a thickness of 2.8 mm The solar chip is connected at its top end to the lower half of a latch, which is removably connected to the top half of the latch which is connected to the lower end of the battery unit. Within the battery unit there are one or more replaceable and rechargeable batteries with a battery life of at least 60 minutes between charges, and a lifetime of 500 recharges. On the outside surface of the battery unit there is an on/off switch to control the operation of the battery unit. Optionally, the on/off switch can control the illumination means in a blinking slow; a blinking fast and a solid light manner. Additionally, the on/off switch can further comprise a sensor that activates upon movement and deactivate upon no movement.

The top end of the battery unit is connected to a plurality of light emitting diodes that illuminate when the on/off switch on the battery unit is moved to the on position. This unit can then be fixed permanently or temporarily to any number of items, e.g. stop signs, belts, and helmets.

Optionally the solar chip battery and illumination means can be attached to the front side or back side of an object which is to be illuminated.

Optionally, the illumination means can be an electroluminescent wire.

Optionally, the illumination means can be light emitting bulbs.

Optionally, the illumination means can be a mesh.

Optionally, the illumination means can be a metal cloth.

According to another preferred version, the solar chip is disposed on the outer surface of a glove. The solar chip is connected at its top end to the lower end of the battery unit which is disposed beneath the outer surface of the glove. The top end of the battery unit is connected to a plurality of light emitting diodes that are also disposed beneath the outer surface of the glove, and are arranged so as to run along the length of the fingers and thumb of the glove. The illuminated glove can be turned on and used for variety of applications, e.g. entertainment and directing traffic.

Optionally, the solar chip battery system can be used for an illumination means on apparel. This includes gloves, safety street jackets, the backside of jackets, arm bands, belts, shoes, caps, bags and hats, where the bags are selected from the group consisting of back bags, brief bags. brief case, school bag, books bags, bicycle back bags, botorcycle back bags and travel bags.

Optionally, the solar chip battery system can be used for illumination means on bicycle, skateboard, skating, and motorcycle accessories and parts. Including helmets, the backside of motorcycle jackets, left and right turn signals, and bike frame lights.

Optionally, the solar chip battery system can be used for illumination means on pet accessories including dog harnesses, dog jackets, leashes, collars, and ties.

Optionally, the solar chip battery system can be used for illumination means on the frames of baby strollers.

Optionally, the solar chip battery system can be used for illumination means for cheering sticks such as those used in sporting events.

Optionally, the solar chip battery system can be used for illumination means on the surface of stop signs. This can include portable or handheld stop signs such as those which are commonly seen at sites of road construction, and fixed stop signs that are commonly seen on many street corners.

These applications benefit from the solar chip battery system used with an illumination means to increase safety, and they also enjoy an aesthetic benefit. The device provides a portable and rechargeable means of powering the illumination means. It overcomes the limitations of having to frequently change batteries because it is rechargeable. The solar chip battery can be used in one embodiment then transferred for use in another embodiment, allowing one device to function in many embodiments. Therefore, the solar chip battery system overcomes many of the problems of similar devices.

### BRIEF DESCRIPTION OF THE DRAWINGS

These and other features, aspects, and advantages of the present invention will become better understood with regard to the following description, and accompanying drawings, where:

FIG. 1 shows an exemplary of the portable, wearable and rechargeable solar chip battery system for use with an illumination means of one embodiment of the present invention;

FIG. 2 shows an exemplary embodiment of the present invention illustrating a latch connecting the solar chip to battery unit;

FIG. 3 shows an exemplary embodiment of the present invention disposed on a stop sign;

FIG. 4 shows an exemplary embodiment of the present invention disposed in a glove;

FIG. 5 shows the front view of an exemplary embodiment of the present invention disposed on a bicycle helmet;

FIG. 5b shows the rear view of an exemplary embodiment of the present invention disposed on a bicycle helmet;

FIG. 5c shows the side view of an exemplary embodiment of the present invention disposed on a bicycle helmet;

FIG. 6 shows the rear view of an exemplary embodiment of the present invention disposed on a skateboard or skating helmet;

FIG. 6b shows the side view of an exemplary embodiment of the present invention disposed on a skateboard or skating helmet;

FIG. 7 shows an exemplary embodiment of the present invention disposed on a safety vest;

FIG. 7b shows an exemplary embodiment of the present invention disposed on a safety vest with the illumination means turned on;

FIG. 8 shows an exemplary embodiment of the present invention removably disposed on a pet harness; and

FIG. 9 shows an exemplary embodiment of the present invention removably disposed on a belt.

### DETAILED DESCRIPTION

All dimensions specified in this disclosure are by way of example only and are not intended to be limiting. Further, the proportions shown in these Figures are not necessarily to scale. As will be understood by those with skill in the art with reference to this disclosure, the actual dimensions and proportions of any system, any device or part of a system or device disclosed in this disclosure will be determined by its intended use.

Methods and devices that implement the embodiments of the various features of the invention will now be described with reference to the drawings. The drawings and the associated descriptions are provided to illustrate embodiments of the invention and not to limit the scope of the invention. Reference in the specification to “one embodiment” or “an embodiment” is intended to indicate that a particular feature, structure, or characteristic described in connection with the embodiment is included in at least an embodiment of the invention. The appearances of the phrase “in one embodiment” or “an embodiment” in various places in the specification are not necessarily all referring to the same embodiment.

Throughout the drawings, reference numbers are re-used to indicate correspondence between referenced elements. In addition, the first digit of each reference number indicates the figure where the element first appears.

As used in this disclosure, except where the context requires otherwise, the term “comprise” and variations of the term, such as “comprising”, “comprises” and “comprised” are not intended to exclude other additives, components, integers or steps.

In the following description, specific details are given to provide a thorough understanding of the embodiments. However, it will be understood by one of ordinary skill in the art that the embodiments may be practiced without these specific detail. Well-known circuits, structures and techniques may not be shown in detail in order not to obscure the embodiments. For example, circuits may be shown in block diagrams in order not to obscure the embodiments in unnecessary detail.

Also, it is noted that the embodiments may be described as a process that is depicted as a flowchart, a flow diagram, a structure diagram, or a block diagram. Although a flowchart may describe the operations as a sequential process, many of the operations can be performed in parallel or concurrently. In addition, the order of the operations may be rearranged. A process is terminated when its operations are completed. A process may correspond to a method, a function, a procedure, a subroutine, a subprogram, etc. When a process corresponds to a function, its termination corresponds to a return of the function to the calling function or the main function.

Moreover, a storage may represent one or more devices for storing data, including read-only memory (ROM), random access memory (RAM), magnetic disk storage mediums, optical storage mediums, flash memory devices and/or other machine readable mediums for storing information. The term “machine readable medium” includes, but is not limited to portable or fixed storage devices, optical storage devices, wireless channels and various other mediums capable of storing, containing or carrying instruction(s) and/or data.

Furthermore, embodiments may be implemented by hardware, software, firmware, middleware, microcode, or a combination thereof. When implemented in software, firmware, middleware or microcode, the program code or code segments to perform the necessary tasks may be stored in a machine-readable medium such as a storage medium or other storage(s). One or more than one processor may perform the necessary tasks in series, distributed, concurrently or in parallel. A code segment may represent a procedure, a function, a subprogram, a program, a routine, a subroutine, a module, a software package, a class, or a combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted through a suitable means including memory sharing, message passing, token passing, network transmission, etc.

In the following descriptions, certain terminology is used to describe certain features of one or more embodiments of the invention.

The term “solar chip” includes but is not limited to solar panels, solar cells, and photovoltaic cells and various other mediums capable of converting of converting the energy of light directly into electricity.

The term “battery” includes but is not limited to electrochemical cells, rechargeable batteries, chemical batteries, secondary batteries, secondary cells, lead-acid batteries, alkaline batteries, zinc-carbon batteries, and other mediums capable of storing and transferring energy to perform work.

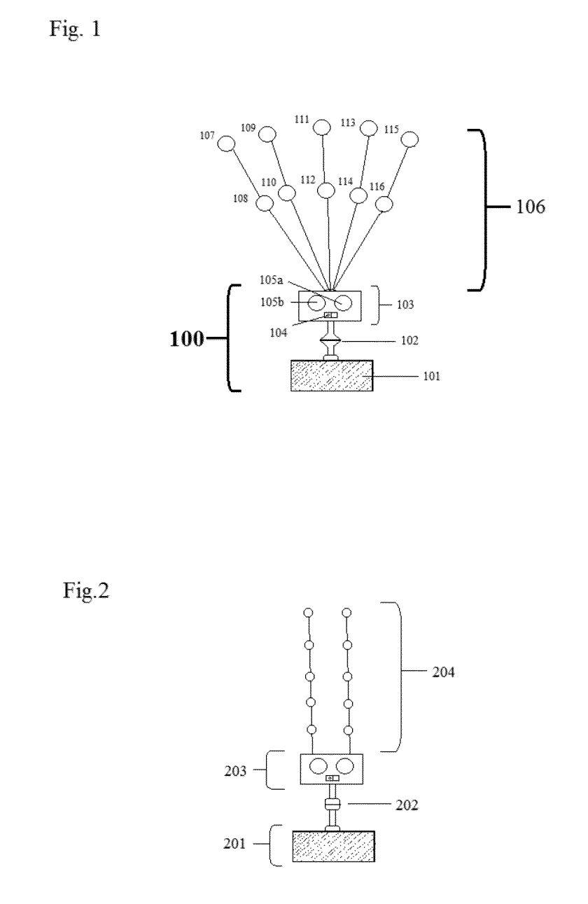

FIG. 1 shows an exemplary of the solar chip, battery unit, and illumination means of one embodiment of the present invention. The apparatus 100 generally includes a solar chip 101. The apparatus 100 also comprises a latch 102 which removably connects in one embodiment of the present invention the solar chip 101 to the battery unit 103. The battery unit 103 further comprises an on/off switch 104 on its surface and at least one battery 105a and 105b). The apparatus 100 may be connected to an illumination means 106. Optionally, the illumination means are light emitting diodes 107, 108, 109, 110, 111, 112, 113, 114, 115, 116. In another embodiment, the on/off switch 104 further comprising a control capable of operating the illumination means in a blinking slow; a blinking fast and a solid light manner. In yet anther embodiment, the on/off switch 104 can further comprise a sensor that activates upon movement and deactivate upon no movement.

FIG. 2 shows an embodiment, where the solar chip 201 is connected at its top end to the lower end of the latch 202. The top end of the latch 202 connects to the lower end of the battery unit. The battery unit connects at its top end to a different illumination means 204. Optionally, the illumination means 204 can be electroluminescent wires, bulbs, mesh, or metal cloth.

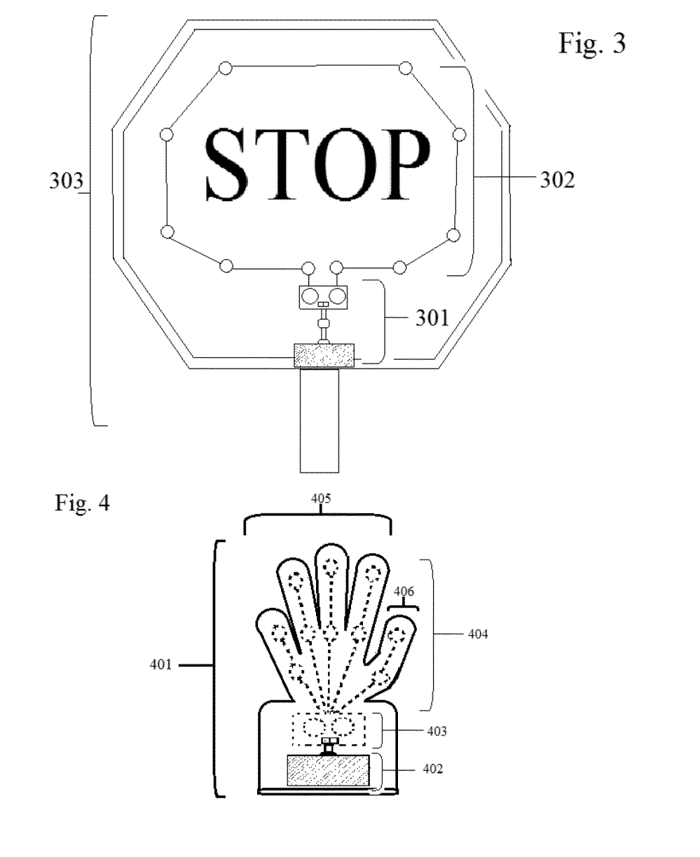

FIG. 3 shows an embodiment where the solar chip and battery apparatus 301 is connected to the illumination means 203. Them both being disposed on the surface of a stop sign 303.

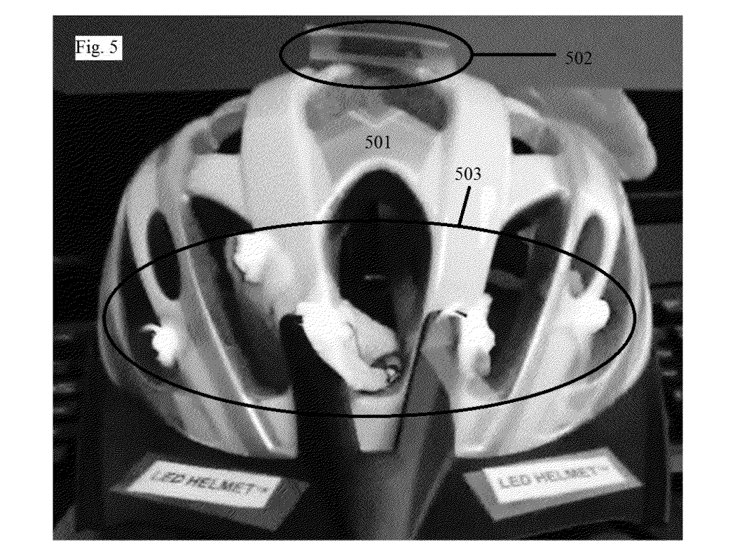

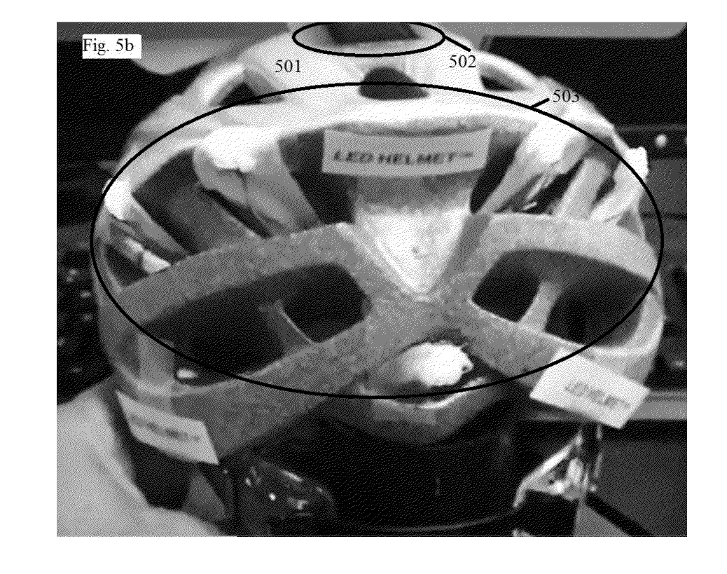

FIG. 4 shows an embodiment where the solar chip 402 is disposed on the outer surface of the glove 401. The solar chip is connected to the battery unit 403 which is disposed below the outer surface of the glove 401. The battery unit being connected to the illumination means 404, which are arranged below the surface of the glove 401 along the length of the fingers 405 and thumb 406 of the glove.

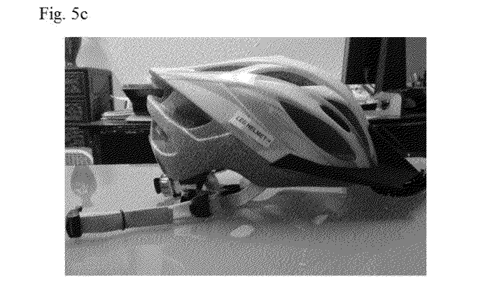

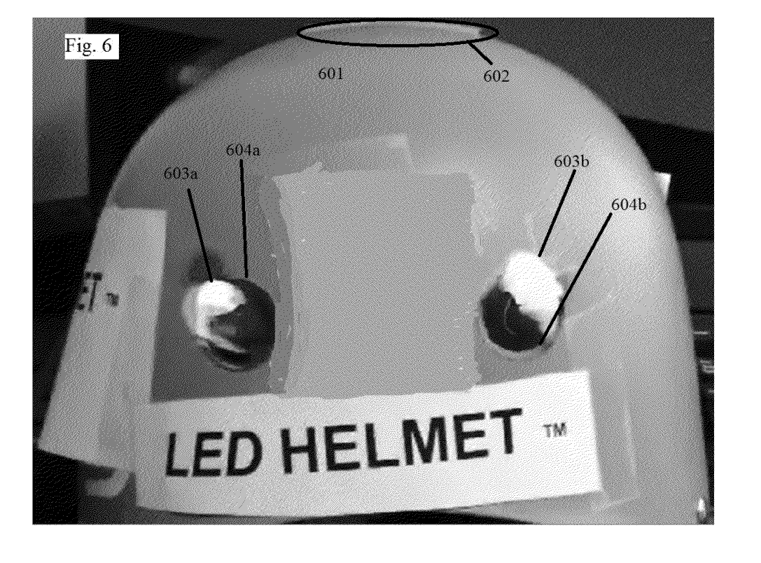

FIG. 5 shows the front view of the embodiment of a bicycle LED helmet 501. The solar chip 502 is disposed on the top of the LED helmet 501 and the illumination means 503 are disposed through the outer surface of the LED helmet 501.

FIG. 5b shows the rear view of the embodiment of a bicycle LED helmet 501. The solar chip 502 is disposed on the top of the LED helmet 501 and the illumination means 503 are disposed through the openings of outer surface of the LED helmet 501.

FIG. 5c shows the side view of an embodiment where the MEKETTA™ solar chip battery connected to an illumination means can be disposed on a bicycle LED helmet 501.

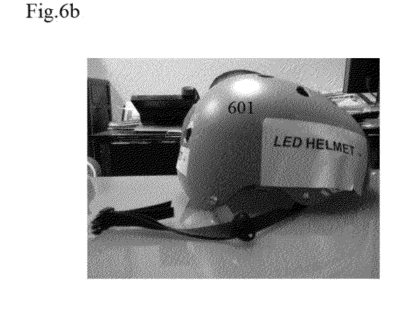

FIG. 6 shows the rear view of an embodiment where the MEKETTA™ solar chip 602 is disposed on the top of the skateboard or skating LED helmet 601. The light emitting diodes 603a, 603b of the illumination means are disposed through openings 604a, 604b of the skateboard or skating LED helmet 601.

FIG. 6b shows the side view of an embodiment where the solar chip battery system connected to an illumination means can be disposed on a skateboard or skating LED helmet 601.

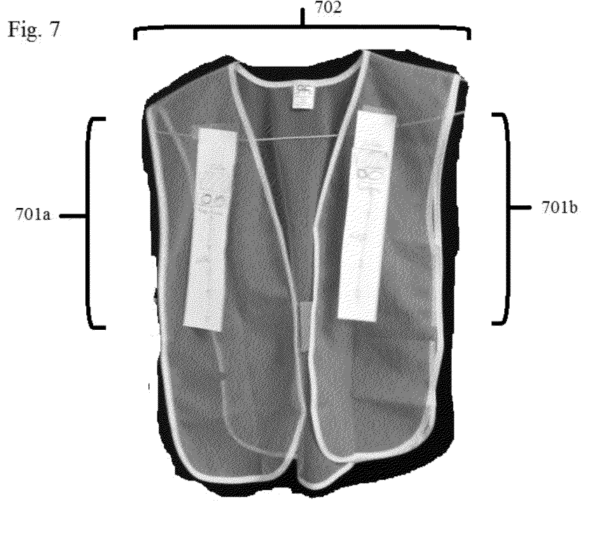

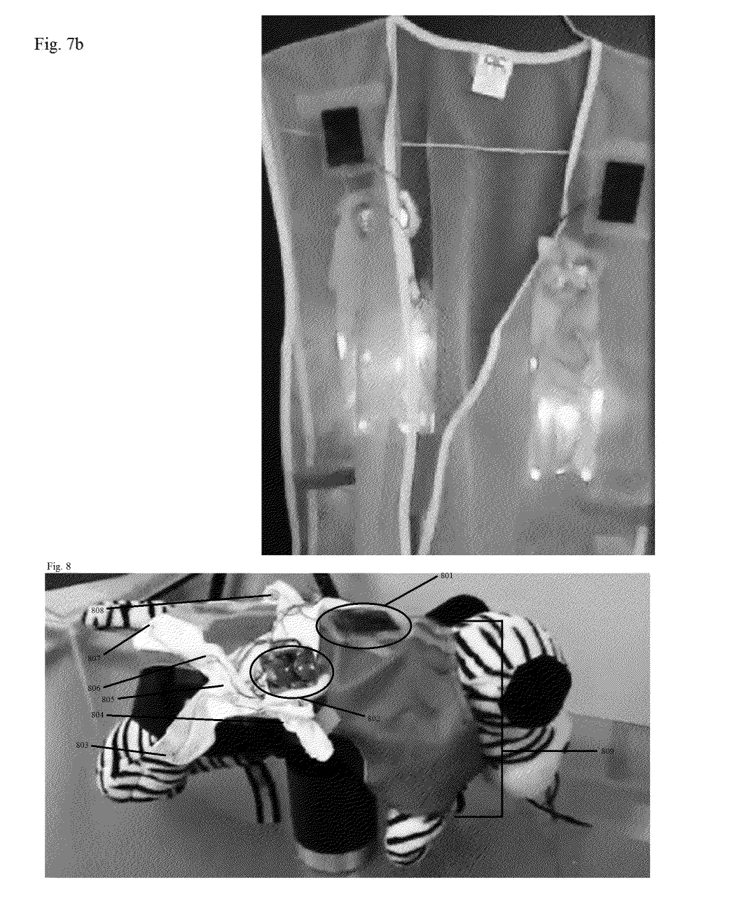

FIG. 7 shows an embodiment where two MEKETTA™ solar chip batteries connected to two illumination means 701 a and 701b are disposed on either side of the front of the safety vest 702. This provides the vest with constant light supplementing the effect of the reflectors when little to no light is present, thereby increasing the safety of the vest.

FIG. 7b shows the safety vest 702 with the illumination means turned on.

FIG. 8 shows an embodiment where the solar chip 801 is connected to the battery unit 802. The battery unit 802 is connected to the illumination means which is of light emitting diodes 803, 804, 805, 806, 807, 808. The solar chip 801, battery unit 802, and illumination means comprising light emitting diodes 803, 804, 805, 806, 807, 808 are removably attached to a pet harness 809. This embodiment illuminates the pet harness for both safety and aesthetic benefit, as well as demonstrating the interchangeability of the MEKETTA™ solar chip battery.

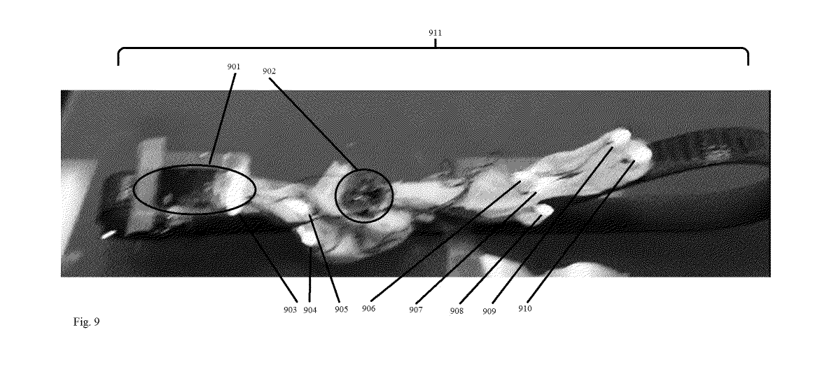

FIG. 9 shows an embodiment where the solar chip 901 is connected to the battery unit 902. The battery unit 902 is connected to the illumination means which is composed of a plurality of light emitting diodes 903, 904, 905, 906, 907, 908, 909, 910. The solar chip 901, battery unit 902, and illumination means comprising light emitting diodes 903, 904, 905, 906, 907, 908, 909, 910 are removably attached to a belt 911.

The present invention has other advantages and the present invention does not require that all the advantageous features and all the advantages need to be incorporated into every embodiment of the present invention. For example, in one embodiment of the present invention the battery unit 403 and the illumination means 404 can be disposed on the surface of the glove 401. In another embodiment of the present invention, the illumination means 106 can be arranged in any number of patterns with a plurality of light emitting diodes, or other suitable alternative including electroluminescent wire, bulbs, mesh, or metal cloth. In other embodiments placed on any of a number of apparel items, including caps, arm bands, jackets, etc. In other embodiments of the present invention, the apparatus 100 may be disposed on apparel, including gloves, safety street jackets, the backside of jackets, arm bands, belts, shoes, caps, bags and hats. In one embodiment the bags are selected from the group consisting of back bags, brief bags. brief case, school bag, books bags, bicycle back bags, botorcycle back bags and travel bags. In other embodiments of the present invention, the apparatus 100 may be disposed on pet accessories including dog harnesses, dog jackets, leashes, collars, and ties. In another embodiment of the present invention, the apparatus 100 may be disposed on frames of baby strollers. In other embodiments of the present invention, the apparatus 100 may be disposed on apparel, including gloves, safety street jackets, the backside of jackets, arm bands, belts, hats, shoes, caps, and hats. In other embodiments of the present invention, the apparatus 100 may be disposed on sports merchandise such as cheering sticks. Therefore, the spirit and scope of the appended claims should not be limited to the description of the preferred versions contained herein.

Insofar as the description above and the accompanying drawing disclose any additional subject matter that is not within the scope of the single claim below, the inventions are not dedicated to the public and the right to file one of more applications to claim such additional inventions is reserved.

What has been described is a new and improved system and method for a remote control for portable electronic devices that is simple operate and operable with a single hand, overcoming the limitations and disadvantages inherent in the related art.

Although the present invention has been described with a degree of particularity, it is understood that the present disclosure has been made by way of example and that other versions are possible. As various changes could be made in the above description without departing from the scope of the invention, it is intended that all matter contained in the above description or shown in the accompanying drawings shall be illustrative and not used in a limiting sense. The spirit and scope of the appended claims should not be limited to the description of the preferred versions contained in this disclosure.

All features disclosed in the specification, including the claims, abstracts, and drawings, and all the steps in any method or process disclosed, may be combined in any combination, except combinations where at least some of such features and/or steps are mutually exclusive. Each feature disclosed in the specification, including the claims, abstract, and drawings, can be replaced by alternative features serving the same, equivalent or similar purpose, unless expressly stated otherwise. Thus, unless expressly stated otherwise, each feature disclosed is one example only of a generic series of equivalent or similar features.

Any element in a claim that does not explicitly state “means” for performing a specified function or “step” for performing a specified function should not be interpreted as a “means” or “step” clause as specified in 35 U.S.C. §112.

What is claimed is:

1. A solar chip battery device suitable for use with an illumination means, the device comprising:
a) a solar chip having a top end;
b) a battery unit having a top end, a lower end, and a surface, where the lower end of the battery unit is connected to the top end of the solar chip;
c) at least one battery removably connected to the surface of the battery unit;
d) an on/off switch coupled to the surface of the battery unit; and
e) an outlet coupled to the top end of the battery unit.

2. The device of claim 1, where the solar chip and battery are connected via a latch having a lower half with a top and bottom, and an upper half with a top and bottom, the bottom of lower half of the latch being connected to the top end of the solar chip, the top of the lower half of the latch being removably connected to the bottom of the upper half of the latch, the top of the upper half of the latch being connected to the lower end of the battery unit.

3. The device of claim 1, where the battery is a rechargeable battery.

4. The device of claim 3, where the battery can discharge for at least 60 minutes before recharge.

5. The device of claim 3, where the battery has a discharge cycle life of least 500.

6. The device of claim 1, where 2 batteries are removably connected to the surface of the battery unit.

7. The device of claim 1, where the solar chip a monocrystalline silicon chip.

8. The device of claim 1, where the solar chip is capable of generating 0.18 W of power.

9. The device of claim 1, where the solar chip has a length dimension of 50 mm, a width dimension of 30 mm, and a thickness dimension of 2.8 mm.

10. The device of claim 1, where the outlet is connected to an illumination means.

11. The device of claim 10, where the illumination means is selected from the group consisting of a light emitting diode, an electroluminescent wire, a light bulb, a metal cloth and a mesh.

12. The device of claim 10, where the illumination means can be disposed on apparel selected from the group consisting of gloves, safety jackets, jackets, arm bands, belts, shoes, caps, bags and hats.

13. The device of claim 12, where the bags are selected from the group consisting of back bags, brief bags. brief case, school bag, books bags, bicycle back bags, botorcycle back bags and travel bags.

14. The device of claim 10, where the illumination means can be disposed on pet accessories, comprising harnesses, jackets, leashes, collars and ties.

15. The device of claim 10, where the illumination means can be disposed on sporting goods selected from the group consisting of a bicycle, a skateboard, skating accessories and motorcycle accessories.

16. The device of claim 10, where the illumination means can be disposed on stop signs, where the stop sign can be portable, fixed or both portable and fixed.

17. The device of claim 10, where the illumination means can be disposed on moveable objects selected from the group consisting of baby strollers, cheering sticks, a glove, a helmet, a pet harness, a belt, a stop sign, a safety jacket, a jacket, an arm band, a hat, a cap, shoes, a pet jacket, a leash, a pet collar, a shirt collar, a tie, a motorcycle jacket, turn signals, a motorcycle frame and a bicycle frame.

18. The device of claim 1, where the on/off switch further comprising a control capable of operating the illumination means in a blinking slow; a blinking fast and a solid light manner.

19. The device of claim, where the on/off switch can further comprise a sensor that activates upon movement and deactivate upon no movement.
